(19) United States
(12) Patent Application Publication
(10) Pub. No.: US 2007/0220029 A1
(43) Pub. Date: Sep. 20, 2007

(54) SYSTEM AND METHOD FOR HIERARCHICAL STORAGE MANAGEMENT USING SHADOW VOLUMES

(75) Inventors: Richard Duane Jones, Elk Ridge, UT (US); Dana M. Henriksen, Lindon, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 11/555,824

(22) Filed: Nov. 2, 2006

Related U.S. Application Data
(60) Provisional application No. 60/783,217, filed on Mar. 17, 2006.

(51) Int. Cl. G06F 7/00

(52) U.S. Cl. 707/101

(57) ABSTRACT

Data partitioned onto two or more storage devices is presented to a user as if the data resided on a single storage area. Data is divided between the storage areas based on policies. Data on the primary storage can utilize frequent back up or other storage management to ensure the accuracy of the data. The data on the secondary storage can employ other data management than the data management for the primary storage. The subdirectory structure is replicated in each area so a data file can be located in either physical area. This allows data files to migrate between the storage areas based on policy.

### RELATED APPLICATION DATA

This application claims priority from U.S. Provisional Patent Application Ser. No. 60/783,217, titled “METHOD FOR HIERARCHICAL STORAGE USING SHADOW VOLUMES”, filed Mar. 17, 2006, which is hereby incorporated by reference for all intents and purposes.

### FIELD OF THE INVENTION

The invention pertains to hierarchical storage management, and more particularly to presenting a union of directly accessible files stored on multiple storage devices, where the files are transparently moved between the storage devices.

### BACKGROUND OF THE INVENTION

Hierarchical Storage Management (HSM) is used to move data from a computer system (such as a server) to a less expensive storage as the data becomes infrequently used. HSM was initially developed to address the problem of filling up expensive computer storage space. There is a general correlation between the ease of accessibility of computer storage and the cost of that storage. In other words, the more accessible a computer storage device is, the more expensive the storage device is. For example, data on a hard drive of a server is more accessible to a user of the server; the user can simply interact with the data on the hard drive. In contrast, data on a backup tape is less accessible to a user. The data must be copied from the backup tape before the user can interact with the data. But in terms of cost, a backup tape is less expensive then a server hard drive.

HSM takes files that have not been used or accessed in a specified amount of time on a primary storage and migrates those files to an alternative storage. A stub of the file metadata is kept on the primary storage, making it appear to the user that the moved files still reside on the primary storage. Retaining the metadata stub on primary storage reminds the user of the existence of the file and provides other information about the file, such as the date the file was last updated or the size of the file.

As computer technology has developed, the cost of storage (including hard disk space) has decreased, while capacity of the storage has increased. Kryder's Law states that over time, hard drives become exponentially more dense in terms of the amount data per size that can be stored on the hard disk. But as storage becomes larger and cheaper, the size of data stored on the devices is also growing. Many people now use their computers to store digital media such as photographs, music and videos. These types of files require a great deal of storage in order to achieve maximal quality. Today, HSM is being used to address the issue of costs related to management of storage with the increased capacity.

HSM works well with applications working with structured data (such as databases). But when an attempt is made to apply HSM to unstructured data, such as end user data on a network, an undesired thrash can occur to the system. This is because a network user can run a tool that forces a migrated file to be de-migrated back to the primary storage. For example, if a user is browsing thumbnail versions of images of files that have been migrated to secondary storage, the metadata stub is insufficient to present the thumbnail to the user. Accordingly, each image has to be retrieved from secondary storage and again stored on the primary storage device. This data retrieval means that the benefits achieved by HSM are now lost: the migrated data is back on the primary storage.

Another weakness of HSM is the existence of file stubs residing in the primary storage. As backup software is executed on the primary storage, the backup software identifies the file stubs, and enumerates the existence of the stubs. This access of the file stubs slows down the backup process since the stubs need to be backed up. This defeats some of the advantages of having migrated the files off of the primary storage. Thus, the benefits that might have been achieved by moving data to alternative storage are not being realized by backup software.

Accordingly, a need exists to be able to store some directory files on a primary storage and other directory files on a secondary storage, while presenting all files in the directory to users as if all files are on the primary storage.

### SUMMARY OF THE INVENTION

Data partitioned onto two or more storage areas is presented to a user as if the data resided on a single storage area. Data is divided between the storage areas based on policies. Data on the primary storage can utilize frequent back up or other storage management to ensure the accuracy of the data. The data on the secondary storage can employ other data management or data protection than is used for the primary storage. The subdirectory structure is replicated in each area so a data file can be located in either physical area. This allows data files to migrate between the storage areas based on policy.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a block diagram of a computer system including a file system interface to present to a client a union of files a primary storage device and a secondary storage device, according to an embodiment of the invention.

FIG. 2 shows the file system interface of FIG. 1 combining and presenting to a client files in a directory on the primary storage and the directory on the secondary storage.

FIG. 3 shows a policy manager with types of migration and retrieval policies used to move files between the primary storage and secondary storage of FIG. 1.

FIG. 4 is a flowchart of the process of the file system interface combining files from the primary storage and the secondary storage of FIG. 1 in response to a client request.

FIG. 5 shows a flowchart of the process of migrating files from the primary storage to the secondary storage of FIG. 1.

FIG. 6 shows a flowchart of the process of retrieving files from the secondary storage to the primary storage of FIG. 1.

### DETAILED DESCRIPTION OF THE PREFERRED EMBODIMENT

In traditional HSM, data is moved off a primary storage device to an alternative and less expensive storage medium, such as a tape or a CD-ROM. Often, the alternative storage medium is not as easy to access: data needs to be migrated back to the primary storage device before it can be accessed by users. File metadata associated with the moved files are preserved in the primary storage so that when a user or an application tries to access the data, (for example, to read the file from the secondary storage), the file system first copies the file back to the primary storage before allowing the user or application to actually access the data. In addition, running a backup program on primary storage that includes metadata for files that have been moved to secondary storage, takes longer than necessary because the backup program also has to backup the metadata residing on the primary storage. Accordingly, this metadata is backed up, even though the file contents are skipped. Even if the backup program knows to look for a specific metadata flag (such as a migrated bit), the backup program must enumerate the file and read the file's metadata to discover that the file is to be passed over.

One problem with the tradition approach to HSM is that the secondary storage media is not directly accessible to clients. A client might see the metadata associated with a moved file, but if the client wants to access the file itself, the file must first be moved from the secondary storage to the primary storage. These retrieved files then occupy space on the primary storage when the objective of HSM was to have the files on a secondary storage so the files do not interfere with the files that are on the primary storage. For example, processes that search through files looking for text, or programs displaying thumbnails, open a file even though the user might not intend to do anything with the file.

One solution to the problem of retrieval of archived files is to mark the file as having been moved to the offline storage. For example, a file can have an attribute in the metadata that says that the file has been migrated to secondary storage. Applications that look for that attribute would then skip the file when the attribute is checked and not open the file. But this solution has its own set of problems. For example, applications must be specifically coded to be aware of the attribute. Applications that are not looking for the migration attribute are unable to take advantage of this solution, thus this solution is not backwards compatible to existing applications. A better solution would be transparent for the application, so the application does not have to change its behavior in order to make HSM work.

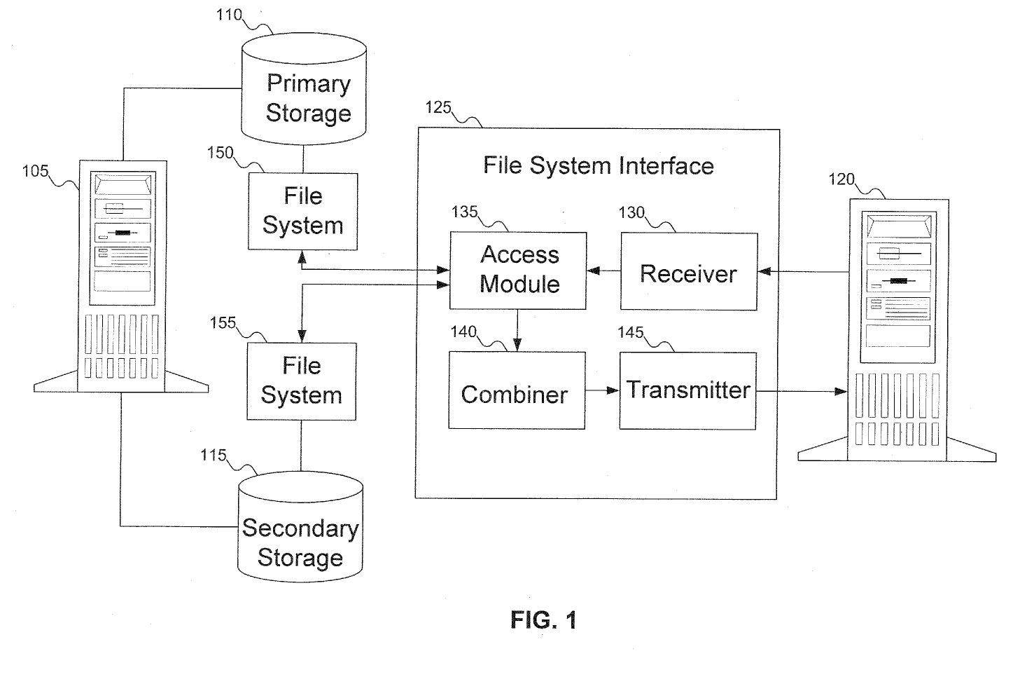

FIG. 1 shows a block diagram of a computer system including a file system interface to present to a client a union of files on a primary storage area and a secondary storage area, according to an embodiment of the invention. Server 105 includes primary storage 110 and secondary storage 115. Primary storage 110 can be used to store active or important files, and secondary storage 115 can be used for data that is inactive or stale, or otherwise determined to be less important. In an embodiment of the invention, secondary storage 115 can be a less expensive form of storage, which might have a slower access time than the access time for primary storage 110. A secondary storage can also be called a shadow volume.

While FIG. 1 shows only one primary storage 110 and one secondary storage 115, a person skilled in the art will recognize that there can be any number of primary and secondary storage devices. In addition, a person skilled in the art will recognize that the various storage devices can be hierarchical. For example, primary storage 110 might include a number of very fast hard drives, with a first level of secondary storage including slower hard drives and a second level of secondary storage including tape backup. Thus, data migration might be between different levels in the hierarchy of the primary and secondary storage devices. In practice, the primary storage device represents only a single level in the hierarchy of storage, but a person skilled in the art will recognize that this is not a limitation of embodiments of the invention.

Client 120 connects to server 105 over a network (not shown in FIG. 1.) Server 105 and client 120 typically include a processor, memory such as random access memory (RAM), read-only memory (ROM), or other state preserving media, storages devices, and input/output interface ports not shown in FIG. 1. In addition, client 120 can include a desktop computer system including a computer, monitor, keyboard, and mouse. Or client 120 can be an application running on server 105. A person skilled in the art will recognize that client 120 can take other forms, such as dumb terminals, Internet appliances, or handheld computing devices such as personal digital assistants (PDAs).

File system interface 125 connects to server 105 and client 120. File system interface 125 receives client requests for data on server 105. File system interface 125 then accesses the primary and secondary storage devices (in FIG. 1, primary storage 110 and secondary storage 115, but a person skilled in the art will recognize that there can be any number of storage devices) to present a view to the user that combines files on primary storage 110 with files on secondary storage 115.

File system interface 125 includes receiver 130, access module 135, combiner 140, and transmitter 145. In an embodiment of the invention, receiver 130 receives a request from client 120 for the files in a directory. The request can seek the files in a particular directory, or the request can be a process searching the entire file systems on the storage devices, among other possibilities. In addition the request can come from a user at the client machine, or the request can be from a client process (e.g., an application running on client 120).

Receiver 130 forwards the request to file access module 135, which accesses both file system 150 on primary storage 110 and file system 155 on secondary storage 115, to obtain the list of files on each storage device satisfying the client request. Combiner 140 then creates a union of the files from the different storage devices, which transmitter 145 transmits back to client 120.

In an embodiment of the invention, primary storage 110 is of a different type from secondary storage 115. For example, primary storage 110 can be a RAID drive system, and secondary storage 115 can be a serial ATA drive. Or the two types of storage can be the same. This is also true for file system 150 and 155. The file systems running on the storage devices can be either different or the same, depending on the preferences of the organization (and possibly the types of the storage devices). For example, primary storage 110 might be a faster and more expensive form of storage. Or secondary storage 115 can be remote storage or otherwise slower. Common to both storage devices is the fact that the storage devices are (theoretically) directly accessible to client 120.

In selecting a type of storage device and file system for primary storage 110 and secondary storage 115, a system administrator can consider the cost of the storage, as well as the cost of managing the storage. An advantage of moving less important files to file system 155 on secondary storage 115 is that the management of that storage can be less expensive than the management of the data on primary storage 110.

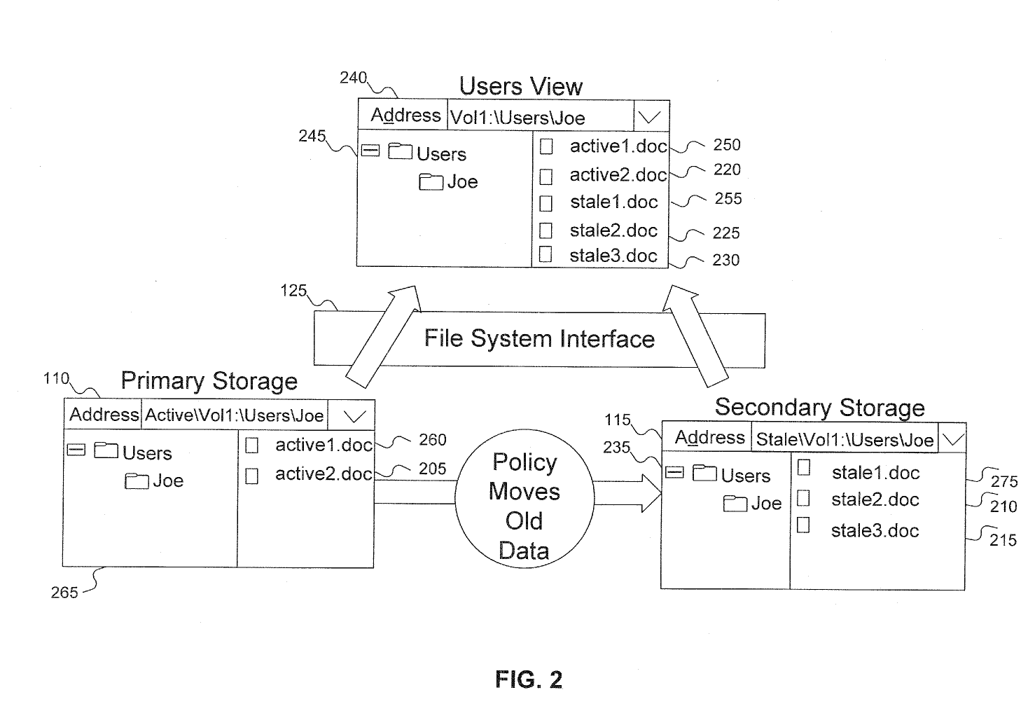

FIG. 2 shows the file system interface of FIG. 1 combining and presenting to a client files in a directory on the primary storage and the directory on the secondary storage. The file system interface allows data to be stored on different devices, yet presented to the user as if all of the data resided on the same device. Primary storage 110 includes file 205 and file 210. Secondary storage 115 includes three files: file 215, file 220 and file 225.

In an embodiment of the invention, a copy (e.g., a mirror) of the subdirectory tree structure on the primary storage is created and stored on the secondary storage. For example, directory tree 235 on secondary storage 115 is the same as directory tree 265 on primary storage 110. Directory tree 235 on secondary storage 115 can mirror the entire tree structure, from the root to the files stored in nested directories.

In addition to mirroring the directory tree in primary storage and the secondary storage, access control information can also be mirrored on the different storage devices. This means that any security policies that are used on the primary storage can also apply on the secondary storage. For example, if a directory is available to some users and unavailable to other users, the information about who has access to the directory might be stored in an access control list. An access control list can grant directory access to a user on an individual basis, or because the user is a member of a group that has access to a directory. Mirroring the access control list from primary storage 110 on to secondary storage 115 enables users to maintain the same access to files regardless where the files reside.

In another embodiment of the invention, secondary storage 115 initially includes a directory structure that differs from directory tree 265 on primary storage 110. In this embodiment, file system 155 uses another method to associate file with particular directories on primary storage 110, and should take care to avoid any naming conflicts arising when two different files with the same name reside in different directories. Needed subdirectories can be added to the directory trees so the directory trees mirror each other. Then files can migrate easily between the two trees.

User view 240 shows directory tree 245, which is also the same as directory tree 235. In FIG. 2, user view 240 shows the files in directory Users\Joe on volume Vol1. User view 240 includes files 250, 220, 255, 225, and 230, showing the files on both primary storage 110 and secondary storage 115.

Because secondary storage 115 is directly accessible storage, it is no longer necessary to retrieve data from secondary storage 115 back to primary storage 110 any time a client wants to modify (or even access) a file on secondary storage 115. Even in cases where the data is modified, it might not be desirable to have the data moved back to primary storage 110. Each storage area is accessible to file system interface 125, and file system interface 125 can read a file in its entirety regardless of which storage the file resides.

Notice that data residing on both primary storage 110 and secondary storage 115 are intermixed in the same folders in the file system. For example, in one embodiment the system can include a policy to migrate data that has not been recently used to the secondary storage, primary storage 110 can be used to store active data (i.e., data that has been recently used), and secondary storage 115 can be used to store stale data (i.e., data that has not been used recently). In this embodiment, the active data can be determined based on the date the file was updated or opened recently. In another embodiment, the system can include a policy to partition data into data that is significant (e.g., data used for work) and data that is less significant (e.g., data used for recreation). In this embodiment, files that are work documents or spreadsheets can be considered active data, versus other files such as MP3 files that are more for recreation than for work purposes. A person skilled in the art will recognize other policies that can be used to partition data among the various storage devices. A migration tool can be used to profile the data and partition it into active data and stale data according to the policy.

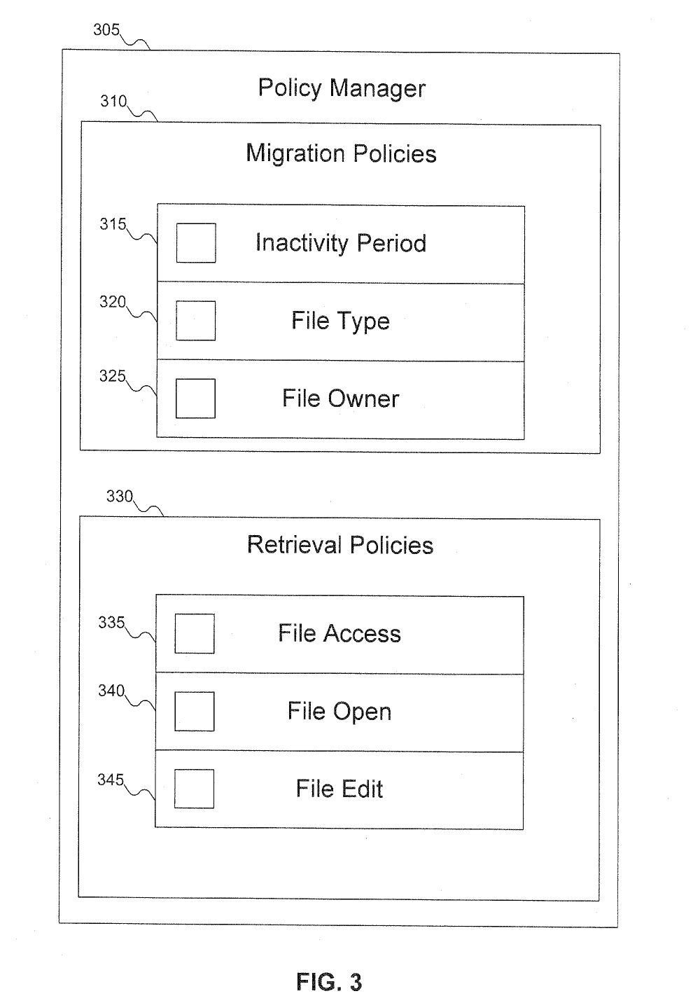

FIG. 3 shows a policy manager including types of migration and retrieval policies to move data between the primary storage and secondary storage of FIG. 1. Policy manager 305 provides an interface for a system administrator to create migration and retrieval policies identifying what data should be moved from primary storage to secondary storage and back. Migration policies 310 allow a partition of data based on a number of different criteria. For example, the migration criteria can be based on a file's last modified time, last access time, file size or even file ownership. In fact, a person skilled in the art will recognize that data can be partitioned based on any file metadata attribute, and migration policies are not limited to only the policies shown in FIG. 3.

Policy manager 305 allows a system administrator to partition the data into data to remain on primary storage, and other data that can be moved to secondary storage. Partitioning the data makes it possible to make a cost-effective use of storage media by using a more expensive storage and file system for primary storage 110, and less expensive storage or file system on secondary storage 115. In addition, a system administrator can also employ a more expensive management of the data on primary storage 110, while spending very little on the management of the data on secondary storage 115. For example, if the primary storage is used to store more active data and the secondary storage is used to store older data, the data on primary storage 110 can be backed up frequently to ensure that a recent backup of the data exists in the event that data needs to be restored from backup. In addition to frequent backups, the primary storage might be replicated to another site for business continuity. The data on secondary storage 115, on the other hand, does not require the same type of expense in terms of performing frequent backups or replication of data.

Migration policies 310 illustrate types of considerations that can control whether a file is moved from primary storage to secondary storage. Inactivity period policy 315 allows the system administrator to specify an amount of time, after which data that has not been accessed can be migrated to secondary storage. Any duration can be used as the time period for inactivity period policy 315. In addition, the system administrator can set up the policy to look for a time period since a file has been opened, or the policy can be based on the amount of time since the file was last modified. For example, if one month is selected as the time period, and the policy is based on opening the file, then if a file on primary storage is not opened in month, then that file is moved to secondary storage according to the policy.

File type policy 320 represents a policy where certain file types are moved from primary storage to secondary storage. This policy can be used when there are certain types of files created on the primary storage that, once created, are not frequently accessed. For example, a log file recording transactions processed by a computer might be created for use to help identify how a data error occurred. If no errors are found, then the log file might not ever be consulted. Although it is important to have this file accessible, it is not usually accessed, so moving the file to secondary storage makes sense.

An example of a file for storage on secondary storage is an audio file or other media file, such as an MP3 file. This type of file is a candidate for migration because the file size is typically large in order to provide the greatest amount of sound quality. And because an MP3 file is usually used for entertainment purposes, rather than work, such a file is less critical to system operation.

Another type of policy is file owner policy 325, that allows a file to be migrated based on who owns the file. For example, current laws and regulations require officers in businesses to retain data for a long period of time. Using file owner policy 325 allows organizations to meet these obligations at a lower cost, since the organization can specifically maintain older data in a secondary storage for the officers subject to the regulations. In addition, by partitioning data by file owner, it is possible to frequently back up data that is owned by a particular file owner, such as a chief executive officer (CEO) for a company.

Another benefit of using file owner policy 325 is that certain users might want to apply a high level of security to the data that is unnecessary for other users. File owner policy 325 enables the users desiring security to have their data moved to an encrypted storage volume. Storing data on an encrypted storage volume allows sensitive data that should not be public to be kept private to all users, other than those specifically authorized to access the data.

Finally, a person skilled in the art will recognize that these are just a few of the possible policies that can be implemented, and that the system administrator can utilize other types of migration policies to automate the moving of a file from primary storage to secondary storage.

In addition, the system administrator can combine policies to provide even greater specificity of the files to migrate. For example, in a system employing multiple secondary storage devices, a system administrator can set up file type policy 320 where all MP3 files are moved to a first secondary storage device. Because these files are not work related, the files on this storage device are not backed up, making the cost of managing the storage less expensive than for storage devices that are backed up. The system administrator can also employ file owner policy 325 to move files owned by a chief financial officer (CFO) to another secondary storage device, where encryption is used on the secondary storage volume, The system administrator can also specify that file type policy 320 takes precedence over file owner policy 325. In this scenario, all MP3 files, even those owned by the CFO are moved to the first secondary storage. A person skilled in the art will recognize that there is no limit to the number of combinations for creating policies based on file metadata.

Recall that the files on the secondary storage devices are directly accessible to users. Retrieval policies 330 include different file interactions with files on the secondary storage that might cause a file to be moved from the secondary storage to the primary storage. File access policy 335 illustrates that if a file on the secondary storage is merely accessed, the file should be moved to the primary storage. For example, file access policy 335 can be implemented in an environment where all files are initially on secondary storage 115. Using file access policy 335 allows users to go about their daily work, and the files the users access are automatically moved to primary storage 110. This migration is a simple way to migrate user data from an old server to a new server with minimal down time.

File open policy 340 is also a broad retrieval policy that in practice might not be employed. File open policy 340 states that if a file on the secondary storage is opened, then that file is migrated back to primary storage. In an embodiment of the invention, the system administrator can configure file open policy 340 so that a process opening up a file (such as a program displaying thumbnails of images) does not trigger the retrieval of a file, but a user opening a file might cause the file to be retrieved.

File modify policy 345 specifies that once a particular file on secondary storage is modified, that file is retrieved to the primary storage. This retrieval policy is useful because modification of a file is an indicator that the file is active. Returning a modified file to the primary storage enables the modifications to receive the protections that are provided to data on the primary storage. Policy manager 305 can include other configurations controlling the retrieval of a migrated file, depending on the preferences of the organization.

Finally, just as migration policies 310 can include types of migration policies that are not shown in FIG. 3, the same is true with the retrieval policies 330. Also, while the description of the policy manager has focused on setting up a policy for an entire volume, it is also possible for the system administrator to use policy manager 305 to set up directory-specific policies. In other words, particular directories within the same volume can have different policies. This is true for both migration policies 310 and retrieval policies 330.

As previously discussed, one advantage of partitioning data among two or more storage devices is that data on the primary storage can be handled differently than data migrated to a secondary storage. One of the costs involved in managing data is the management of backing up data. In an embodiment of the invention, different backup procedures can be employed for the data depending on where the data resides.

For example, some organizations have terabytes of data for their users. This data is backed up regularly, and kept on redundant storage devices to be readily available if the data is corrupted. Regular backup of data can be expensive in terms of time and storage capacity.

Data that is infrequently accessed has low value to the user and does not need frequent backup. In an embodiment of the invention, the system administrator responsible for backing up the data can employ different backup procedures for the data stored on the primary storage than the data stored on the secondary storage. This way the data on the primary storage can be backed up at a high frequency, e.g., nightly, and the data on the secondary storage can be backed up less frequently, such as weekly, monthly or quarterly. Finally, if data is restored from backup because of a catastrophic failure, the files stored on the primary storage can be restored first. The secondary data can then be restored at a later time.

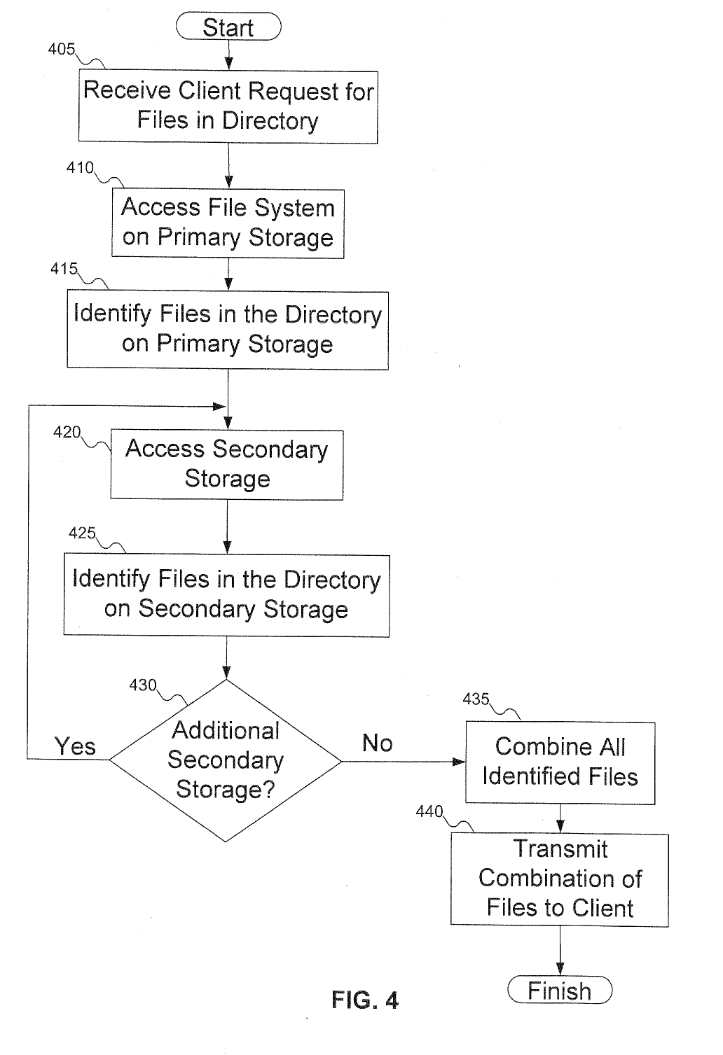

FIG. 4 is a flowchart of the process of the file system interface combining files from the primary storage and the secondary storage of FIG. 1 in response to a client request. At step 405, a client requests the files in a directory. As discussed above, in an embodiment of the invention, files can be moved from a directory on primary storage to a second storage in order to manage storage space on the primary storage. However, the files moved to the secondary storage are still accessible to clients, and the client can interact with the moved files as if the files were still on the primary storage. The client request can be for the names of the files and the metadata for the files. It can also be a request for access to the files (e.g., to open one or more files using an appropriate application).

At step 410, a file system on a primary storage device is accessed. At step 415 the files in the directory on the primary storage are identified. While steps 410 and 415 assume only a single primary storage, a person skilled in the art will recognize that there can be multiple primary storage devices, each of which would be accessed to determine the complete list of files in the identified directory.

At step 420, a secondary storage device is accessed. Then at step 425, the files corresponding to the directory are identified on the secondary storage. In an embodiment of the invention, the secondary storage device includes a directory tree structure that is the same as the directory tree on the primary storage.

At decision block 430, if there is another secondary storage device then the process returns to step 420 where that storage device is accessed and then step 425 where the files in the directory are identified. Once all of the files for the appropriate directory are identified, at step 435 the files are combined, and at step 440 the combined list of the files is transmitted to the user at the client.

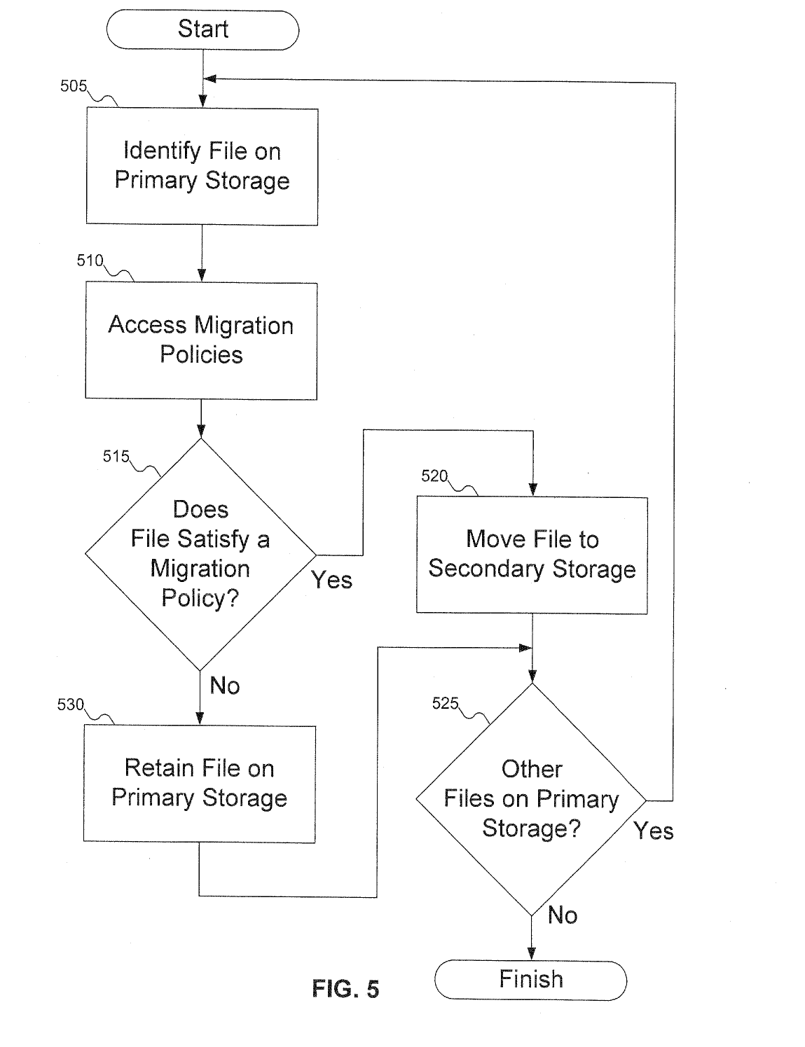

FIG. 5 shows a flowchart of the process of migrating files from the primary storage to the secondary storage of FIG. 1. At step 505, the policy manager identifies a file on the primary storage. At step 510, the policy manager accesses migration policies controlling the migration of files from primary storage to secondary storage. Recall that the policy manager can manage several migration policies, even enabling a system administrator to create a sophisticated set of criteria determining what data to migrate to a particular secondary storage device. As explained in the description of FIG. 2, there can be migration policies based on a date the file is last updated, who owns the file, or the type of file, etc.

At decision block 515, if the file satisfies a migration policy, then at step 520, the file is moved to secondary storage according to the policy. In an embodiment of the invention, if multiple secondary storage devices are used, then the policy determines the secondary storage to move the file. For example, a file owner policy can specify that all files by a CEO are moved to a first secondary storage, and then all other files can be handled by a file inactivity policy specifying the migration of a file to a different secondary storage. At decision block 525, if there are any other files on primary storage, then the process returns to step 505 for further evaluation.

If at decision block 515 the file metadata does not satisfy a migration policy, then at step 530 the file is retained on the primary storage. Note that this process can be set up to run according to a schedule, such as nightly or weekly. Scheduling the migration enables files to be partitioned for optimal storage management.

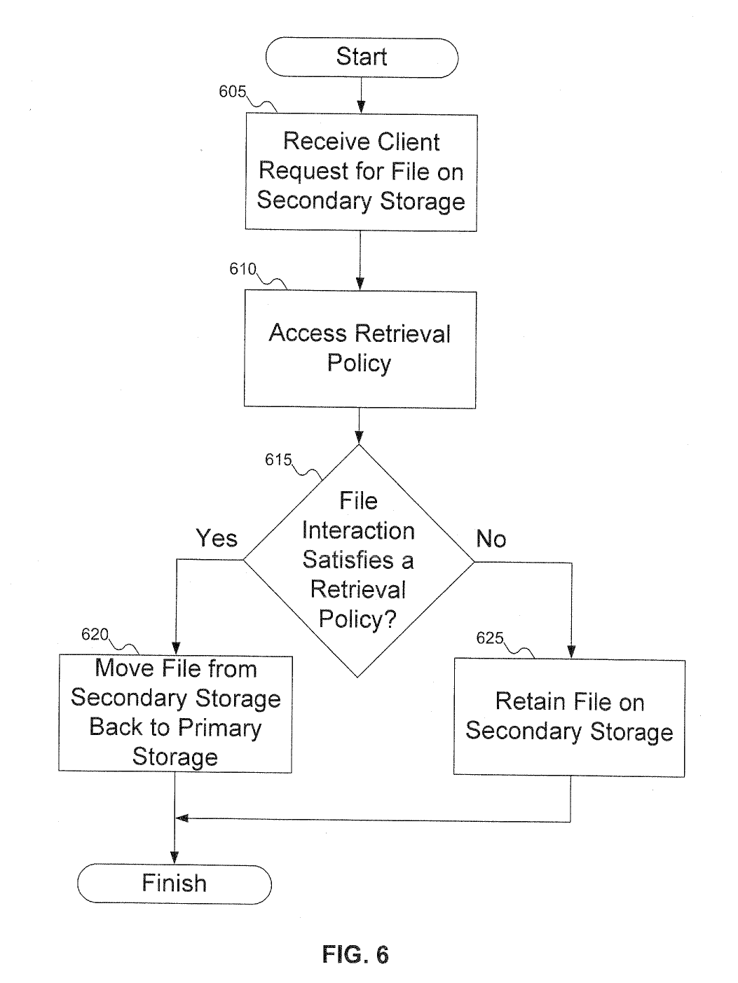

FIG. 6 shows a flowchart of the process of retrieving files from the secondary storage to the primary storage of FIG. 1. At step 605 the file system interface receives a client request for a file residing on secondary storage. At step 610, the retrieval policies are accessed. Decision block 615 asks if the client request is for a file interaction satisfying a retrieval policy. For example, a retrieval policy might specify that opening a file on secondary storage does not cause the file to be moved back to primary storage, but that modification of a file is an indicator that the file is to be retrieved from secondary storage.

Just as with the migration policies, there can be multiple retrieval policies controlling the retrieval of a file on secondary storage back to the primary storage. One retrieval policy can be based on what secondary storage the file is stored on. Another might be system-wide based on the opening of a file. In practice a system administrator can also create a combination of retrieval policies enabling a sophisticated process to control the retrieval of a file.

If the client interaction with the file satisfies the file retrieval policy, then at step 620 the file is moved from the secondary storage back to the primary storage. If the client interaction with the file does not satisfy a retrieval policy, then at step 625 the file is retained on the secondary storage.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And although the foregoing discussion has focused on particular embodiments and examples, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
a computer;
a primary storage;
a first file system installed on the primary storage, the first file system including a first directory tree structure;
a second storage;
a second file system installed on the second storage, the second file system including a second directory tree structure;
a means for synchronizing the first directory tree structure with the secondary directory tree structure;
a receiver to receive a request from a client for a list of files in a directory;
a file access module to directly access the first file system and identify a first list of files on the first storage and to directly access the second file system and identify a second list of file on the second storage;
a combiner to combine the first list of files and the second list of files into a combined list; and
a transmitter to transmit the combined list to the client.

2. A system according to claim 1, further comprising a file mover to move a file from the primary storage to the second storage according to a migration policy.

3. A system according to claim 2, wherein the migration policy includes a file inactivity policy.

4. A system according to claim 2, wherein the migration policy includes a file type policy.

5. A system according to claim 2, wherein the migration policy includes a file owner policy.

6. A system according to claim 1, further comprising a file retriever to retrieve the file from the second storage back to the primary storage according to a reverse migration policy.

7. A system according to claim 1, wherein:
the system further comprises:
a third storage; and
a third file system installed on the third storage;
the file system access module is operative to access the third file system and identify a third list of files; and
the combiner is operative to combine the third list of files with the combined list.

8. A system according to claim 1, further comprising a directory interface to enable the client to access a file in the second list of files without retrieving the file from the second storage back to primary storage.

9. A system according to claim 1, wherein the means for synchronizing the first directory tree structure with the secondary directory tree structure includes an access control list copier to copy an access control list from the primary storage to the second storage.

10. A computer-implemented method of using shadow volumes to manage file storage, comprising:
synchronizing a first directory tree structure with a second directory tree structure, the first directory tree structure organizing a first file system on a primary storage, and the second directory tree structure organizing a second file system on a second storage;
receiving a client request for a list of files in a directory;
accessing the first file system on the primary storage;
identifying a first list of files in the directory on the primary storage;
accessing the second file system on the second storage;
identifying a second list of files in the directory on the second storage;
combining the first list of files and the second list of files into a combined list; and
transmitting the combined list to the client.

11. A method according to claim 10, wherein receiving a client request includes intercepting a file system request from the client for the list of files in the directory.

12. A method according to claim 10, further comprising:
accessing a migration policy;
determining if a file in a directory on the primary storage satisfies the migration policy; and
moving the file from the directory on the primary storage to a corresponding directory on the secondary storage if the file satisfies the migration policy.

13. A method according to claim 12, wherein:
accessing a migration policy includes accessing a file inactivity policy; and
determining if the file satisfies the migration policy includes determining if the file has not been opened for an amount of time specified in the file inactivity policy.

14. A method according to claim 12, wherein:
accessing a migration policy includes accessing a file type policy; and
determining if the file satisfies the migration policy includes determining if the file is a file type specified by the file type policy.

15. A method according to claim 12, wherein:
accessing a migration policy includes accessing a file owner policy; and
determining if the file satisfies the migration policy includes determining if the file is owned by a file owner specified in the file owner policy.

16. A method according to claim 10, wherein synchronizing a first directory tree structure with a second directory tree structure includes synchronizing an access control list on the primary storage with an access control list on the second storage.

17. A method according to claim 10, further comprising:
accessing a reverse migration policy;
determining if the file on the secondary storage satisfies the reverse migration policy; and
moving the file from the second storage back to the directory on the primary storage if the file satisfies the reverse migration policy.

18. A method according to claim 10, wherein:
the method further comprises:
accessing a third file system on a third storage; and
identifying a third list of files in the directory on the third storage; and
combining the first list of files and the second list of files into a combined list includes combining the first list of files, the second list of files, and the third list of files into the combined list.

19. An article, comprising a storage medium, said storage medium having stored thereon instructions, that, when executed by a machine, result in:
synchronizing a first directory tree structure with a second directory tree structure, the first directory tree structure organizing a first file system on a primary storage, and the second directory tree structure organizing a second file system on a second storage;
receiving a client request for a list of files in a directory;
accessing the first file system on the primary storage;
identifying a first list of files in the directory on the primary storage;
accessing the second file system on the second storage;
identifying a second list of files in the directory on the second storage;
combining the first list of files and the second list of files into a combined list;
transmitting the combined list to the client.

20. An article according to claim 19, wherein receiving a client request includes intercepting a file system request from the client for the list of files in the directory.

21. An article according to claim 19, further comprising:
accessing a migration policy;
determining if a file in a directory on the primary storage satisfies the migration policy; and
moving the file from the directory on the primary storage to a corresponding directory on the secondary storage if the file satisfies the migration policy.

22. An article according to claim 21, wherein:
accessing a migration policy includes accessing a file inactivity policy; and
determining if the file satisfies the migration policy includes determining if the file has not been opened for an amount of time specified in the file inactivity policy.

23. An article according to claim 21, wherein:
accessing a migration policy includes accessing a file type policy; and
determining if the file satisfies the migration policy includes determining if the file is a file type specified by the file type policy.

24. An article according to claim 21, wherein:
accessing a migration policy includes accessing a file owner policy; and
determining if the file satisfies the migration policy includes determining if the file is owned by a file owner specified in the file owner policy.

25. An article according to claim 19, wherein synchronizing a first directory tree structure with a second directory tree structure includes synchronizing an access control list on the primary storage with an access control list on the second storage.

26. An article according to claim 19, further comprising:
accessing a reverse migration policy;
determining if the file on the secondary storage satisfies the reverse migration policy; and
moving the file from the second storage back to the directory on the primary storage if the file satisfies the reverse migration policy.

27. An article according to claim 26, further comprising:
accessing a third file system on a third storage;
identifying a third list of files in the directory on the third storage; and
combining the third list of files into the combined list with the first list of file and the second list of files.
